(19) United States
(12) Patent Application Publication
(10) Pub. No.: US 2025/0266513 A1
(43) Pub. Date: Aug. 21, 2025

(54) BATTERY MANAGEMENT SYSTEM AND BATTERY MANAGEMENT METHOD

(71) Applicant: ROHM Co., Ltd., Kyoto (JP)

(72) Inventor: Takayoshi FUJINO, Yokohama (JP)

(73) Assignee: ROHM Co., Ltd., Kyoto (JP)

(21) Appl. No.: 19/053,348

(22) Filed: Feb. 13, 2025

(30) Foreign Application Priority Data
Feb. 20, 2024 (JP) 2024-023747

(51) Int. Cl. H01M 10/42; H01M 10/48

(52) U.S. Cl. CPC H01M 10/425; H01M 10/482; H01M 2010/4271

(57) ABSTRACT

A battery management system includes multiple measurement circuits, a communication circuit performing communication with each of the multiple measurement circuits, and a battery manager managing each of multiple batteries. The battery manager acquires a turnaround time for each of the multiple measurement circuits, measures a communication delay time between each of the multiple measurement circuits and the communication circuit for each of the multiple measurement circuits based on the turnaround time, and aligns timings at which each of the multiple measurement circuits performs analog-to-digital conversion on measurement data of at least one of a voltage and a current transmitted, based on the turnaround time corresponding to each of the multiple measurement circuits.

### CROSS-REFERENCE TO RELATED APPLICATION

This application claims the priority benefit of Japan application serial no. 2024-023747, filed on Feb. 20, 2024. The entirety of the above-mentioned patent application is hereby incorporated by reference herein and made a part of this specification.

### BACKGROUND

### Technical Field

The disclosure relates to a battery management system and a battery management method.

### Related Art

In a battery management system (BMS) disclosed in Patent Document 1 (Japanese Patent Application Laid-Open No. 2015-076890), multiple communication circuits mounted at battery cells (batteries) are connected in a daisy chain in a manner capable of bidirectional communication, and are managed by a battery manager (MCU). The BMS includes multiple monitoring circuits that monitor a voltage (cell voltage) of each of the multiple batteries, a current (cell current) flowing to each of the multiple batteries, etc.

The multiple monitoring circuits are connected in a daisy chain. To measure a remaining capacity and a degradation of the battery with high accuracy, the BMS desirably aligns measurement start timings of the cell voltage and the battery current in the multiple monitoring circuits.

However, since distances of communication paths from the battery manager to each of the multiple monitoring circuits connected in a daisy chain differ from each other, even if the battery manager transmits a measurement start signal for measuring the cell voltage and the like in each monitoring circuit, different delay times occur until the measurement start signal reaches individual monitoring circuits. Accordingly, the timings at which each monitoring circuit starts measurement of the cell voltage and the like becomes misaligned.

Thus, in the related art, a delay time (ADC delay) from a time point at which each monitoring circuit receives the measurement start signal until each monitoring circuit starts measurement of the cell voltage and the like, i.e., until starting an analog-to-digital conversion (ADC) action, is set in each of the monitoring circuits. By measuring in advance the communication delay time of when each monitoring circuit receives the measurement start signal, it is possible to align the measurement start timings of the cell voltage and the like in each monitoring circuit.

However, the communication delay time from each of the monitoring circuits to the MCU may differ due to lengths of cables wired in the communication path, properties of components present in the periphery of the communication path, etc. Thus, even if the delay time until each monitoring circuit starts the analog-to-digital conversion action is set in each of the monitoring circuits, there may still be variations in the timings at which each of the monitoring circuits performs analog-to-digital conversion on the measurement data such as the measured cell voltage.

### SUMMARY

A battery management system according to an embodiment of the disclosure includes multiple measurement circuits, a communication circuit, and a battery manager. The multiple measurement circuits are connected in series in a daisy chain by a serial communication line and measure at least one of a voltage and a current of each of multiple batteries included in a battery pack. The communication circuit is connected to the multiple measurement circuits in a loop by the serial communication line and performs communication with each of the multiple measurement circuits. The battery manager manages each of the multiple batteries. The battery manager is configured to: acquire a turnaround time of a signal transmitted and received between each of the multiple measurement circuits and the communication circuit for each of the multiple measurement circuits; measure a communication delay time between each of the multiple measurement circuits and the communication circuit for each of the multiple measurement circuits based on the acquired turnaround time; and align timings at which each of the multiple measurement circuits starts analog-to-digital conversion of at least one of the voltage and the current based on the communication delay time corresponding to each of the multiple measurement circuits.

A battery management method according to an embodiment of the disclosure is a battery management method executed by a battery management system. The battery management system includes multiple measurement circuits, a communication circuit, and a battery manager. The multiple measurement circuits are connected in series in a daisy chain by a serial communication line and measures at least one of a voltage and a current of each of multiple batteries included in a battery pack. The communication circuit is connected to the multiple measurement circuits in a loop by the serial communication line and performs communication with each of the multiple measurement circuits. The battery manager manages each of the multiple batteries. The battery manager acquires a turnaround time of a signal transmitted and received between each of the multiple measurement circuits and the communication circuit for each of the multiple measurement circuits. The battery manager transmits a measurement start signal indicating that each of the multiple measurement circuits starts the measurement to each of the multiple measurement circuits. Each of the multiple measurement circuits transmits, to the communication circuit, measurement data obtained by measuring at least one of the voltage and the current based on the measurement start signal. The battery manager aligns timings at which each of the multiple measurement circuits performs analog-to-digital conversion of at least one of the voltage and the current based on the turnaround time corresponding to each of the multiple measurement circuits.

### BRIEF DESCRIPTION OF THE DRAWINGS

FIG. 1 is a configuration view of a battery management system 100 according to an embodiment of the disclosure.

FIG. 2 is a flowchart for describing an action of the battery management system 100 according to an embodiment of the disclosure.

FIG. 3 is a diagram for describing the action of the battery management system 100 according to an embodiment of the disclosure.

FIG. 4 is a block diagram showing a hardware configuration of a computer 300.

### DESCRIPTION OF THE EMBODIMENTS

Embodiments of the disclosure provide a battery management system and a battery management method that align timings of performing analog-to-digital conversion on voltages measured by multiple circuits.

Hereinafter, embodiments will be illustrated with reference to the drawings. Same functions or configurations will be labeled with same or similar reference signs, and descriptions thereof will be omitted as appropriate.

### Embodiment

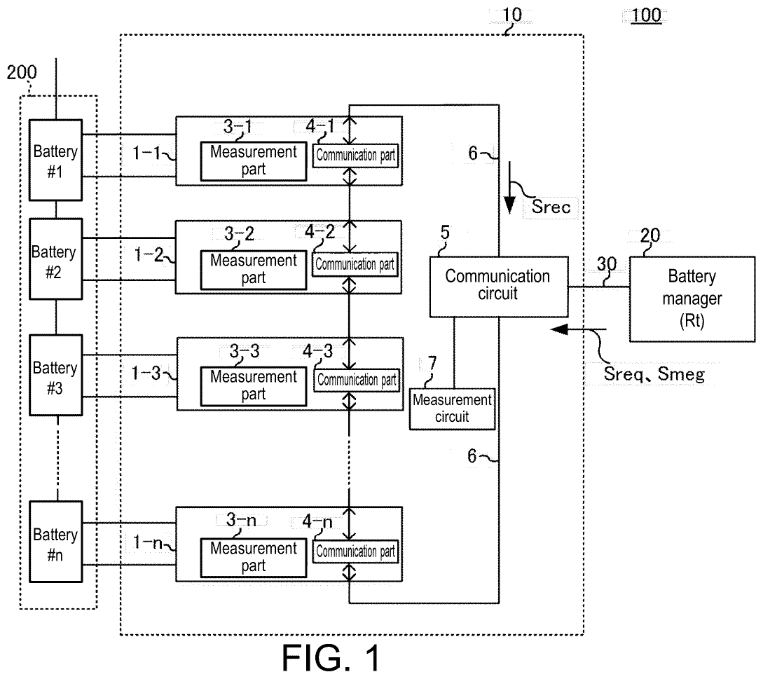

FIG. 1 is a configuration view of a battery management system 100 according to an embodiment of the disclosure. The battery management system 100 may be interpreted as a circuit that monitors a voltage (cell voltage) of each of multiple batteries included in a battery pack 200, a current (cell current) flowing to each of the multiple batteries, etc. Each of the multiple batteries may be interpreted as a battery cell, may be interpreted as a battery stack including multiple battery cells therein, or may be interpreted as a battery module including multiple battery stacks therein.

The battery management system 100 may include a communication system 10, a battery manager 20, and a network 30.

### Network 30

The network 30 connects between the battery manager 20 and the communication system 10. As an example, the network 30 may be a controller area network (CAN).

### Communication System 10

The communication system 10 is communicably connected to the battery manager 20 via the network 30. The communication system 10 may include a communication circuit 5 and a communication device group. The communication device group includes multiple communication devices, and the multiple communication devices may be interpreted as measurement circuits 1-1 to 1-n, a measurement circuit 7, etc. The measurement circuits 1-1 to 1-n and the measurement circuit 7 may each be realized by a computer including a processor.

### Communication Circuit 5

The communication circuit 5 may be connected to the multiple measurement circuits 1-1 to 1-n in a loop by a serial communication line 6. The communication circuit 5 may perform bidirectional communication with each of the multiple measurement circuits 1-1 to 1-n via the serial communication line 6. The communication circuit 5 may perform bidirectional communication with the battery manager 20 via the network 30. The communication circuit 5 may be realized by a computer including a processor.

### Measurement Circuits 1-1 to 1-n

Each of the multiple measurement circuits 1-1 to 1-n may be connected in series in a daisy chain by the serial communication line 6. The daisy chain may be interpreted as a connection configuration in which three or more circuits are connected by cables for communication. Hereinafter, to simplify the description, each of the multiple measurement circuits 1-1 to 1-n may be referred to as a measurement circuit 1 unless specifically stated otherwise.

Each of the multiple measurement circuits 1 may measure at least one of a voltage and a current of each of multiple batteries included in the battery pack 200. Specifically, upon receiving a measurement start signal Smeg from the communication circuit 5, each of the multiple measurement circuits 1 may start analog-to-digital conversion of at least one of the voltage and the current, and transmit at least one of the voltage and the current, which have been analog-to-digital converted, as measurement data to the battery manager 20.

Each of the multiple measurement circuits 1 may monitor a state of each of the multiple batteries included in the battery pack 200 and specify a battery that is malfunctioning. Each of the multiple measurement circuits 1 may set identification information for specifying each of the multiple measurement circuits 1 to each of multiple measurement parts 3-1 to 3-n. Accordingly, it is possible to specify positions of the batteries serving as monitoring targets of the multiple measurement parts 3-1 to 3-n, i.e., positions of each of the multiple batteries included in the battery pack 200. Accordingly, the battery manager 20 can also be enabled to identify a transmission source of a reception signal Srec.

The measurement circuit 1-1 may include a measurement part 3-1 and a communication part 4-1. Similarly, the measurement circuit 1-2 may include a measurement part 3-2 and a communication part 4-2, the measurement circuit 1-3 may include a measurement part 3-3 and a communication part 4-3, and the measurement circuit 1-n may include a measurement part 3-n and a communication part 4-n. The measurement parts 3-1 to 3-n may each measure a voltage of a battery.

### Measurement Part 3-1 to Measurement Part 3-n

The measurement part 3-1 may measure a voltage generated in a battery #1 and a current flowing to the battery #1. Similarly, the measurement part 3-2 may measure a voltage generated in a battery #2 and a current flowing to the battery #2. The measurement part 3-3 may measure a voltage generated in a battery #3 and a current flowing to the battery #3. The measurement part 3-n may measure a voltage generated in a battery #n and a current flowing to the battery #n.

### Communication Parts 4-1 to 4-n

The communication part 4-1 is communicably connected to the adjacent communication part 4-2. Similarly, the communication part 4-2 is communicably connected to the adjacent communication part 4-3. The communication part 4-n is communicably connected to an adjacent communication part (not shown). In this manner, a daisy chain is formed by connecting the communication parts 4-1 to 4-n adjacent to each other.

The serial communication line 6 is connected to the measurement circuit 1-1 constituting one end of the daisy chain, and the serial communication line 6 is connected to the measurement circuit 1-n constituting the other end of the daisy chain. Accordingly, the communication parts 4-1 to 4-n and the communication circuit 5 are connected in a loop by the serial communication line 6.

The communication part 4-1 may transmit measurement data indicating values such as the voltage and the current measured by the measurement part 3-1 to the communication circuit 5. Similarly, the communication part 4-2 may transmit measurement data measured by the measurement part 3-2 to the communication circuit 5. The communication part 4-3 may transmit measurement data measured by the measurement part 3-3 to the communication circuit 5. The communication part 4-n may transmit measurement data measured by the measurement part 3-n to the communication circuit 5.

The multiple measurement circuits 1 configured in this manner each start measurement of at least one of the voltage and the current in the case of receiving, from the communication circuit 5, a measurement start signal Smeg indicating starting measurement of at least one of the voltage and the current.

### Measurement Circuit 7

The measurement circuit 7 may measure a current flowing to the battery pack 200 and transmit measurement data indicating a measured current value to the communication circuit 5.

### Battery Manager 20

The battery manager 20 may manage each of the multiple batteries included in the battery pack 200. Specifically, the battery manager 20 may request measurement of at least one of the voltage and the current of each of the multiple batteries included in the battery pack 200, collect data measured in response to the request, and execute various controls based on the collected measurement data.

Specifically, for each of the multiple measurement circuits 1, the battery manager 20 may acquire a turnaround time Rt of a signal transmitted and received between each of the multiple measurement circuits 1 and the communication circuit 5. In the case where there are multiple measurement circuits 7, the battery manager 20 may similarly acquire a turnaround time Rt with respect to each of the multiple measurement circuits 7.

The battery manager 20 may transmit a measurement start signal Smeg, which indicates that each of the multiple measurement circuits 1 starts measurement, to each of the multiple measurement circuits 1 via the communication circuit 5.

The battery manager 20 may measure a communication delay time based on the turnaround time Rt. Specifically, for each of the multiple measurement circuits 1, the battery manager 20 may measure a communication delay time between each of the multiple measurement circuits 1 and the communication circuit 5. In the case where there are multiple measurement circuits 7, the communication circuit 5 may similarly measure a communication delay time with respect to the multiple measurement circuits 7.

The turnaround time Rt may be interpreted as a time from a time point at which the communication circuit 5 transmits a specific signal to each of the multiple measurement circuits 1 in a specific direction of the serial communication line 6, until the communication circuit 5 receives a signal indicating that each of the multiple measurement circuits 1-1 to 1-n has received the signal.

Specifically, the turnaround time Rt may be interpreted as a time from a time point at which the communication circuit 5 transmits a turnaround request signal Sreq to each of the multiple measurement circuits 1 in a specific direction of the serial communication line 6, until the communication circuit 5 receives a reception signal Srec, which indicates that each of the multiple measurement circuits 1 has received the turnaround request signal Sreq, as a result of each of the multiple measurement circuits 1 transmitting the reception signal Srec in a direction opposite to the specific direction.

The specific direction may be interpreted as any one of a first direction or a second direction around the serial communication line 6. Specifically, in the case where the multiple measurement circuits 1-1 to 1-n are connected in a daisy chain to the serial communication line 6 in the order of the measurement circuit 1-1, the measurement circuit 1-2, the measurement circuit 1-n, and the communication circuit 5, the first direction around the serial communication line 6 may be interpreted as a direction in which the communication circuit 5, the measurement circuit 1-1, the measurement circuit 1-2, the measurement circuit 1-n, and the communication circuit 5 are arranged in this order. The second direction around the serial communication line 6 may be interpreted as a direction opposite to the first direction. In the case where the specific direction is the first direction, the direction opposite to the specific direction may be interpreted as the second direction. In the disclosure, the configuration and the action of the communication system 10 are described assuming that the specific direction of the serial communication line 6 is the first direction.

The battery manager 20 may align timings at which each of the multiple measurement circuits 1 starts analog-to-digital conversion of at least one of the voltage and the current, based on the turnaround time Rt corresponding to each of the multiple measurement circuits 1.

Specifically, in the case where a communication time between the battery manager 20 and the measurement circuit 1-1, i.e., a turnaround time Rt, is X1, a time of half of X1 becomes a communication delay time (td1) from a time point at which the measurement circuit 1-1 starts measurement of the voltage and the like until the battery manager 20 or the communication circuit 5 receives measurement data. The battery manager 20 transmits a measurement start signal Smeg to the measurement circuit 1-1 at a time point after the communication delay time (td1) has elapsed from a specific time point (T). The communication delay time (td1) is, for example, 10 msec. In the case of transmitting the measurement start signal Smeg to the measurement circuit 1-1, the battery manager 20 may receive identification information specifying the measurement circuit 1-1 from the measurement circuit 1-1, and based on this identification information, transmit the measurement start signal Smeg to the measurement circuit 1-1. The battery manager 20 may transmit information indicating the communication delay time (td1) to the measurement circuit 1-1, and the measurement circuit 1-1 receiving this information may start analog-to-digital conversion at a time point after the communication delay time (td1) has elapsed from the specific time point (T).

In the case where the turnaround time Rt between the battery manager 20 and the measurement circuit 1-2 is X2, a time of half of X2 becomes a communication delay time (td2) from a time point at which the measurement circuit 1-2 starts measurement of the voltage and the like until the battery manager 20 or the communication circuit 5 receives the measurement data. The battery manager 20 transmits a measurement start signal Smeg to the measurement circuit 1-2 at a time point after the communication delay time (td2) has elapsed from the specific time point (T). The communication delay time (td2) is a time shorter than the communication delay time (td1), and is, for example, 9 msec. The battery manager 20 may transmit information indicating the communication delay time (td2) to the measurement circuit 1-2, and the measurement circuit 1-2 receiving this information may start analog-to-digital conversion at a time point after the communication delay time (td2) has elapsed from the specific time point (T).

In the case where the turnaround time Rt between the battery manager 20 and the measurement circuit 1-3 is X3, a time of half of X3 becomes a communication delay time (td3) from a time point at which the measurement circuit 1-3 starts measurement of the voltage and the like until the battery manager 20 or the communication circuit 5 receives the measurement data. The battery manager 20 transmits a measurement start signal Smeg to the measurement circuit 1-3 at a time point after the communication delay time (td3) has elapsed from the specific time point (T). The communication delay time (td3) is a time shorter than the communication delay time (td2), and is, for example, 8 msec. The battery manager 20 may transmit information indicating the communication delay time (td3) to the measurement circuit 1-3, and the measurement circuit 1-3 receiving this information may start analog-to-digital conversion at a time point after the communication delay time (td3) has elapsed from the specific time point (T).

In this manner, the battery manager 20 measures the communication delay times (td1, td2, td3, etc.) and, considering these communication delay times, transmits the measurement start signal Smeg to each of the multiple measurement circuits 1 at an appropriate timing. Accordingly, it is possible to align the timings at which each of the multiple measurement circuits 1 performs analog-to-digital conversion of at least one of the voltage and the current.

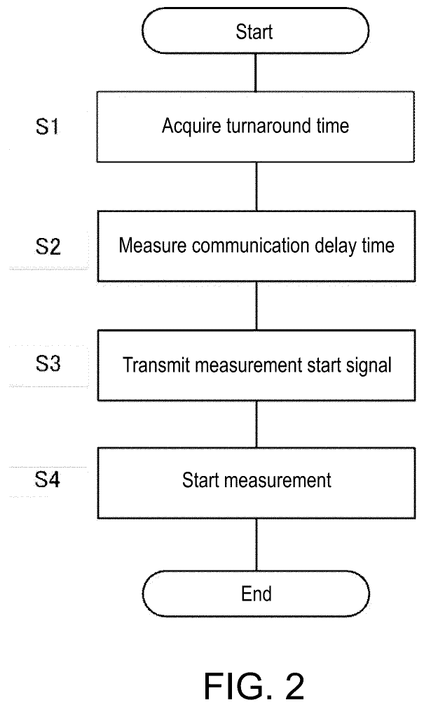

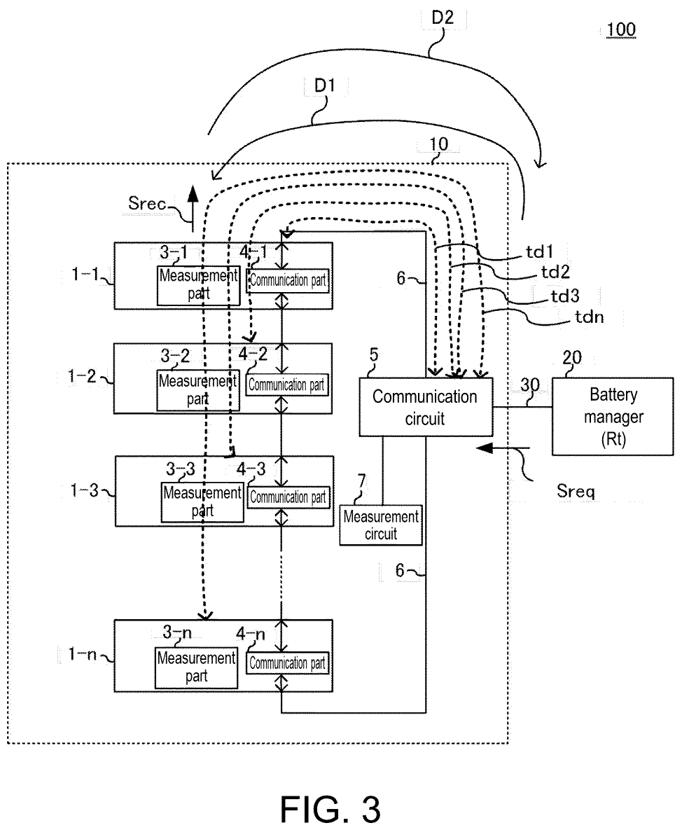

Next, the action of the battery management system 100 will be described with reference to FIG. 2 and FIG. 3. FIG. 2 is a flowchart for describing the action of the battery management system 100 according to an embodiment of the disclosure. FIG. 3 is a diagram for describing the action of the battery management system 100 according to an embodiment of the disclosure.

In step S1, the battery manager 20 acquires a turnaround time Rt.

Specifically, as shown in FIG. 3, the battery manager 20 transmits a turnaround request signal Sreq to each of the multiple measurement circuits 1 in a specific direction (first direction D1) around the serial communication line 6 by the communication circuit 5. Each of the multiple measurement circuits 1 transmits a reception signal Srec in a direction (second direction D2) opposite to the specific direction. The battery manager 20 may acquire a turnaround time Rt by measuring a time from the time point of transmitting the turnaround request signal Sreq to the time point at which the battery manager 20 receives the reception signal Srec.

In step S2, the battery manager 20 measures a communication delay time (td1, td2, td3, tdn) between each of the multiple measurement circuits 1 and the communication circuit 5 based on the turnaround time Rt for each of the multiple measurement circuits.

In step S3, the battery manager 20 transmits a measurement start signal Smeg to each of the multiple measurement circuits 1 based on the communication delay time (td1, td2, td3, tdn) corresponding to each of the multiple measurement circuits 1, to align the timings at which the multiple measurement circuits 1 start measurement of at least one of the voltage and the current.

In step S4, each of the multiple measurement circuits 1 receiving the measurement start signal Smeg starts measurement of at least one of the voltage and the current at the timing at which the measurement start signal Smeg is received. In other words, each of the multiple measurement circuits 1 starts analog-to-digital conversion of at least one of the voltage and the current. The at least one of the voltage and the current, which have been analog-to-digital converted, is transmitted to the battery manager 20 as measurement data.

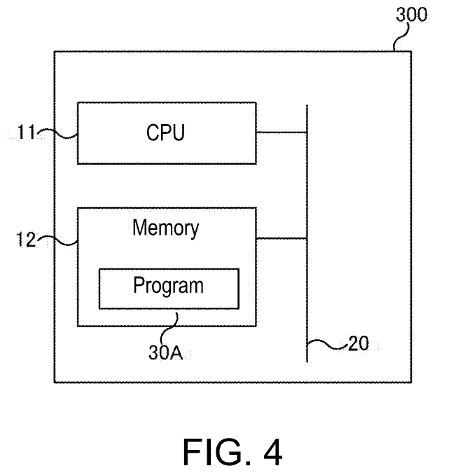

FIG. 4 is a block diagram showing a hardware configuration of a computer 300. The computer 300 may be interpreted as the battery manager 20.

The computer 300 may include a central processing unit (CPU) 11 and a memory 12. The CPU 11 and the memory 12 are communicably connected to each other via a bus 20.

The CPU 11 is a central processing unit that executes various programs and controls various parts. The memory 12 stores various programs 30A and various data. The memory 12 temporarily stores programs or data as a work area. The program 30A may include a program for battery management.

The control processing performed by the CPU 11 reading and executing software (program) in the above embodiment may also be executed by various processors other than the CPU. In that case, examples of the processor include a programmable logic device (PLD) such as a field-programmable gate array (FPGA) capable of changing a circuit configuration after manufacturing, a dedicated electric circuit such as an application specific integrated circuit (ASIC) which is a processor having a circuit configuration specifically designed for executing specific processing, etc. In addition, the control processing may be executed by one of such various processors, or may be executed by a combination of two or more processors of the same or different types (e.g., a combination of multiple FPGAs, a combination of a CPU and an FPGA, etc.). In addition, the hardware structure of such various processors is more specifically an electric circuit combining circuit elements such as semiconductor elements.

### Action and Effect

As described above, the battery management system 100 of the disclosure adjusts transmission timings of the measurement start signal Smeg to align the timings at which each of the multiple measurement circuits 1 performs analog-to-digital conversion of at least one of the voltage and the current, based on the communication delay time corresponding to each of the multiple measurement circuits 1. Accordingly, even in cases where the communication delay time from each monitoring circuit to the MCU may differ due to lengths of cables wired in the communication path, properties of components present in the periphery of the communication path, etc., measurement synchronization of the voltage and the current can be enhanced, i.e., the timings of analog-to-digital conversion can be aligned, compared to a method of measuring a communication delay time in advance as in the related art.

The following supplementary notes are further disclosed with respect to the above descriptions.

### Supplementary Note 1

A battery management system including:
multiple measurement circuits connected in series in a daisy chain by a serial communication line and measuring at least one of a voltage and a current of each of multiple batteries included in a battery pack;
a communication circuit connected to the multiple measurement circuits in a loop by the serial communication line and performing communication with each of the multiple measurement circuits; and
a battery manager managing each of the multiple batteries, in which
the battery manager is configured to:
acquire a turnaround time of a signal transmitted and received between each of the multiple measurement circuits and the communication circuit for each of the multiple measurement circuits,
measure a communication delay time between each of the multiple measurement circuits and the communication circuit for each of the multiple measurement circuits based on the acquired turnaround time, and
align timings at which each of the multiple measurement circuits performs analog-to-digital conversion on at least one of the voltage and the current based on the communication delay time corresponding to each of the multiple measurement circuits.

### Supplementary Note 2

The battery management system according to Supplementary Note 1, in which
the turnaround time is a time from a time point at which the communication circuit transmits a turnaround request signal to each of the multiple measurement circuits in a specific direction of the serial communication line, until the communication circuit receives a reception signal, which indicates that each of the multiple measurement circuits has received the turnaround request signal, as a result of each of the multiple measurement circuits transmitting the reception signal in a direction opposite to the specific direction.

### Supplementary Note 3

The battery management system according to Supplementary Note 2, in which
the specific direction is any one of a first direction and a second direction around the serial communication line.

### Supplementary Note 4

The battery management system according to any one of Supplementary Notes 1 to 3, in which
the battery manager transmits a measurement start signal indicating that each of the multiple measurement circuits starts measurement of at least one of the voltage and the current, based on the communication delay time corresponding to each of the multiple measurement circuits.

### Supplementary Note 5

A battery management method executed by a battery management system, the battery management system including:
multiple measurement circuits connected in series in a daisy chain by a serial communication line and measuring at least one of a voltage and a current of each of multiple batteries included in a battery pack;
a communication circuit connected to the multiple measurement circuits in a loop by the serial communication line and performing communication with each of the multiple measurement circuits; and
a battery manager managing each of the multiple batteries,
the battery management method including:
acquiring, by the battery manager, a turnaround time of a signal transmitted and received between each of the multiple measurement circuits and the communication circuit for each of the multiple measurement circuits;
transmitting, by the battery manager, a measurement start signal indicating that each of the multiple measurement circuits starts the measurement to each of the multiple measurement circuits;
transmitting, by each of the multiple measurement circuits, to the communication circuit, measurement data obtained by measuring at least one of the voltage and the current based on the measurement start signal; and
aligning, by the battery manager, timings at which each of the multiple measurement circuits performs analog-to-digital conversion on the transmitted measurement data based on the turnaround time corresponding to each of the multiple measurement circuits.

What is claimed is:

1. A battery management system comprising:
a plurality of measurement circuits connected in series in a daisy chain by a serial communication line and measuring at least one of a voltage and a current of each of a plurality of batteries included in a battery pack;
a communication circuit connected to the plurality of measurement circuits in a loop by the serial communication line and performing communication with each of the plurality of measurement circuits; and
a battery manager managing each of the plurality of batteries, wherein
the battery manager is configured to:
acquire a turnaround time of a signal transmitted and received between each of the plurality of measurement circuits and the communication circuit for each of the plurality of measurement circuits,
measure a communication delay time between each of the plurality of measurement circuits and the communication circuit for each of the plurality of measurement circuits based on the acquired turnaround time, and
align timings at which each of the plurality of measurement circuits starts analog-to-digital conversion of at least one of the voltage and the current based on the communication delay time corresponding to each of the plurality of measurement circuits.

2. The battery management system according to claim 1, wherein
the turnaround time is a time from a time point at which the communication circuit transmits a turnaround request signal to each of the plurality of measurement circuits in a specific direction of the serial communication line, until the communication circuit receives a reception signal, which indicates that each of the plurality of measurement circuits has received the turnaround request signal, as a result of each of the plurality of measurement circuits transmitting the reception signal in a direction opposite to the specific direction.

3. The battery management system according to claim 2, wherein
the specific direction is any one of a first direction and a second direction around the serial communication line.

4. The battery management system according to claim 1, wherein
the battery manager transmits a measurement start signal indicating that each of the plurality of measurement circuits starts measurement of at least one of the voltage and the current, based on the communication delay time corresponding to each of the plurality of measurement circuits.

5. A battery management method executed by a battery management system, the battery management system comprising:
a plurality of measurement circuits connected in series in a daisy chain by a serial communication line and measuring at least one of a voltage and a current of each of a plurality of batteries included in a battery pack;
a communication circuit connected to the plurality of measurement circuits in a loop by the serial communication line and performing communication with each of the plurality of measurement circuits; and
a battery manager managing each of the plurality of batteries,
the battery management method comprising:
acquiring, by the battery manager, a turnaround time of a signal transmitted and received between each of the plurality of measurement circuits and the communication circuit for each of the plurality of measurement circuits;
measuring, by the battery manager, a communication delay time between each of the plurality of measurement circuits and the communication circuit for each of the plurality of measurement circuits based on the acquired turnaround time; and
aligning, by the battery manager, timings at which each of the plurality of measurement circuits performs analog-to-digital conversion of at least one of the voltage and the current based on the communication delay time corresponding to each of the plurality of measurement circuits.

6. The battery management method according to claim 5, wherein
the turnaround time is a time from a time point at which the communication circuit transmits a turnaround request signal to each of the plurality of measurement circuits in a specific direction of the serial communication line, until the communication circuit receives a reception signal, which indicates that each of the plurality of measurement circuits has received the turnaround request signal, as a result of each of the plurality of measurement circuits transmitting the reception signal in a direction opposite to the specific direction.

7. The battery management method according to claim 6, wherein
the specific direction is any one of a first direction and a second direction around the serial communication line.

8. The battery management method according to claim 5, wherein
the battery manager transmits a measurement start signal indicating that each of the plurality of measurement circuits starts measurement of at least one of the voltage and the current, based on the communication delay time corresponding to each of the plurality of measurement circuits.
